(19) United States
(12) Patent Application Publication
(10) Pub. No.: US 2026/0210853 A1
(43) Pub. Date: Jul. 23, 2026

(54) INFRARED ABSORBANCE-MODULATED EVANESCENT SCATTERING MICROSCOPY

(71) Applicant: Trustees of Boston University, Boston, MA (US)

(72) Inventors: Ji-Xin Cheng, Newton, MA (US); Qing Xia, Boston, MA (US)

(73) Assignee: Trustees of Boston University, Boston, MA (US)

(21) Appl. No.: 19/457,731

(22) Filed: Jan. 23, 2026

Related U.S. Application Data
(60) Provisional application No. 63/748,710, filed on Jan. 23, 2025.

(51) Int. Cl. G01N 21/552; G01N 1/44; G01N 21/39; G01N 21/65; G01N 21/71

(52) U.S. Cl. CPC G01N 21/553; G01N 1/44; G01N 21/39; G01N 21/718; G01N 21/658

(57) ABSTRACT

Infrared absorbance-modulated evanescent scattering systems and methods are disclosed along with uses for such in label-free chemical fingerprinting of bio-nanoparticles. Systems and methods can include directing a mid-infrared (IR) beam at an oblique angle onto a portion of a sample located on a gold-coated substrate to induce a temperature change in the portion by absorption of the mid-IR beam while simultaneously directing a probe beam onto the gold-coated substrate to generate a laterally-propagating evanescent field while detecting orthogonally scattered probe light from the sample using a detector. Applications can include distinguishing empty from cargo-loaded lipid nanoparticles and analyzing adeno-associated virus particles providing advancements in gene therapy, vaccine development, and biological research.

### CROSS-REFERENCE TO RELATED APPLICATIONS

This application claims the benefit of and priority to U.S. Provisional Application Ser. No. 63/748,710, filed Jan. 23, 2025, the content of which is incorporated herein by reference in its entirety.

### FIELD OF INVENTION

The present disclosure pertains to chemical imaging technologies, specifically to infrared absorbance-modulated evanescent scattering microscopy and applications thereof in label-free analysis and fingerprinting of bio-nanoparticles.

### BACKGROUND

In recent years, chemical imaging of nanoscale biological assemblies has gained significant attention in research, driven by advances in vibrational spectroscopy and photothermal detection. Techniques that probe molecular vibrations-such as infrared absorption and Raman scattering-provide chemical specificity without requiring external labels. Mid-infrared photothermal imaging builds upon these concepts by converting molecular absorption into localized temperature changes, which can be detected via optical modulation. Surface-sensitive methods and high-throughput detection techniques have been investigated to improve sensitivity and facilitate the study of sub-100-nm particles.

Despite significant progress, existing methods face unavoidable trade-offs among sensitivity, spatial resolution, speed, and throughput. Optical approaches provide complementary access to single-particle detection of protein aggregates, yet no existing modality can obtain label-free vibrational fingerprints of individual oligomers in their native aqueous environment. Fluorescence imaging achieves single-molecule sensitivity but requires extrinsic labels and lacks intrinsic structural specificity. Surface-enhanced vibrational spectroscopies provide single-molecule chemical information, yet suffer from strong hotspot-dependent variability, which limits reproducibility and quantitative interpretation. Near-field infrared (IR) nano-spectroscopy resolves secondary structures with nanoscale resolution, but its throughput is low and measurements are largely restricted to dried samples or fibrils. Far-field interferometric scattering achieves exceptional sensitivity and throughput for detecting single proteins in solution but lacks chemical contrast, leaving the structure and composition of individual oligomers unresolved.

In particular, the rapid, label-free chemical profiling of individual nanoparticles in the 20-300 nm range remains out of reach for most platforms. Accurately distinguishing empty from cargo-loaded particles at video-rate speeds is challenging due to limited photothermal modulation depth and competing heat dissipation pathways. Achieving high spatial fidelity while maintaining spectral fidelity across the fingerprint region requires overcoming optical diffraction limits and optimizing interactions at the surface. Moreover, methods that excel in one performance metric frequently compromise others, underscoring the need for a streamlined imaging modality capable of high-throughput, single-particle chemical analysis in both air and thin aqueous layers.

### SUMMARY

Systems and methods of the invention provide label-free single-molecule spectroscopic imaging through infrared absorbance-modulated evanescent scattering (IR-AMES), which encodes mid-IR vibrational information into interferometric evanescent scattering and allows vibrational imaging of single proteins under native aqueous conditions. The disclosed systems and methods build on the photothermal principle where conventional coaxial photothermal detection faces an intrinsic sensitivity limit: the scattering changes induced by Δr and Δn have opposite contributions that partially cancel, suppressing the detectable modulation depth. The systems and methods herein can overcome this limitation using an orthogonal photothermal detection scheme. In various embodiments, a surface-confined evanescent probe field can be used to enhance interferometric scattering and an IR-reflective gold-coated substrate with 45° mid-IR incidence can be used to double the interfacial pump field intensity. The horizontally propagating evanescent wave then allows scattering to be collected orthogonally, eliminating cancellation between photothermal contributions and increasing modulation depth by more than two orders of magnitude compared with coaxial detection. Together, these advances can provide label-free vibrational imaging of individual proteins in solution using standard quantum-cascade laser (QCL) mid-IR sources. Accordingly, the disclosed systems and methods can be used as a general platform for high-throughput, label-free chemical imaging of individual biomolecules and nanoscale assemblies.

A broad range of applications stands to benefit from this reliable, noninvasive chemical imaging at the single-particle level. In the field of gene therapy, characterization of delivery vectors and carriers is critical for ensuring delivery efficiency, safety, and batch-to-batch consistency. Quality control workflows demand accurate ratios of full, empty, and partially loaded particles, as well as precise quantification of payloads in individual particles. Vaccine manufacturing relies on carriers for delivery, where loading heterogeneity and formulation effects can influence efficacy. Beyond therapeutics, label-free nanoscale imaging supports studies of extracellular vesicles, protein aggregates, and other complex biological assemblies in their native environments.

Aspects of the invention can include systems for label-free, single molecule spectroscopic imaging. Systems can include a gold-coated substrate; a mid-infrared (IR) optical source for generating a mid-IR beam, the mid-IR beam being directed at an oblique angle onto a portion of a sample located on the gold-coated substrate to induce a temperature change in the portion by absorption of the mid-IR beam; a probe source for generating a probe beam, the probe beam being directed onto the gold-coated substrate to generate a laterally-propagating evanescent field; and a detector for detecting orthogonally scattered probe light from the sample.

Systems can further include a data acquisition and processing system for acquiring and processing the detected orthogonally scattered probe light from the sample to produce an IR-encoded scattering image based on differences between scattering detected during mid-IR beam excitation of the sample and scattering detected without mid-IR beam excitation of the sample. The gold-coated substrate can be glass. Systems can include a barrier positioned to block reflected probe beam light.

In certain embodiments, the mid-IR beam may be directed onto the portion of the sample at a 45 degree angle of incidence. The mid-IR beam can be pulsed. The mid-IR beam may be p-polarized. In some embodiments, the mid-IR beam may be pulsed in pulses of about 80 ns. The probe beam may be a nanosecond pulsed 450-nm laser. In various embodiments, the probe beam and mid-IR beam pulses can be synchronized. The detector can include a cmos camera.

In certain aspects, methods of the invention can include label-free, single molecule spectroscopic imaging. Methods can include steps of: generating a mid-infrared (IR) beam using a mid-IR optical source; directing the mid-infrared (IR) beam at an oblique angle onto a portion of a sample located on a gold-coated substrate to induce a temperature change in the portion by absorption of the mid-IR beam; generating a probe beam using a probe source; directing the probe beam onto the gold-coated substrate to generate a laterally-propagating evanescent field; and detecting orthogonally scattered probe light from the sample using a detector.

In some embodiments, a label-free method for chemical imaging of individual bio-nanoparticles is provided. Methods can include providing a planar reflective substrate and positioning one or more bio-nanoparticles on the surface of the substrate; illuminating the substrate at an angle above a critical angle with a probe laser to cause total internal reflection and generate evanescent field and collecting evanescent scattering orthogonally using a CMOS camera. A pulsed mid-IR beam is simultaneously directed at the same region of the sample at an oblique angle to heat the region through IR absorption, thereby inducing a photothermal effect observable in the difference in collected evanescent scattering between IR-on and IR-off frames as the beams are synchronously pulsed. By scanning the IR wavenumber, hyperspectral image stacks can be generated, from which vibrational fingerprints of individual molecules can be obtained with molecular composition and structure signatures.

In various embodiments, systems and methods of the invention can include fingerprinting various gene delivery vectors including individual adeno-associated virus (AAV) particles, allowing discrimination of genomic cargo at the single-particle level. The gold film surface can be functionalized with thiol-linked capture molecules such as antibodies, aptamers, or peptides to selectively bind target bio-nanoparticles. These and other features of the disclosure will be apparent from the following detailed description.

### BRIEF DESCRIPTION OF DRAWINGS

FIG. 1 shows a microscopy system implementation and concept according to various embodiments.

FIG. 2 shows performance of microscopy systems according to certain embodiments.

FIG. 3 shows the results of fingerprinting of single proteins under native conditions using microscopy systems of the invention according to certain embodiments.

FIG. 4 shows the results of label-free fingerprinting of single AAV particles using microscopy systems of the invention according to certain embodiments.

FIG. 5 shows a numerical comparison of probe-field intensity and photothermal modulation in coaxial versus orthogonal-evanescent detection.

FIG. 6 shows simulated IR field intensity on a gold-coated substrate at different incident angles (0).

FIG. 7 shows a water-suppression strategy allowing detection of nanoparticles in aqueous environments.

FIG. 8 shows spectral peak assignment of reference biomolecules in solution using microscopy systems of the invention according to certain embodiments.

FIG. 9 shows topological polarization rotation of IR light to p polarization state.

FIG. 10 shows signal acquisition and synchronization for microscopy systems of the invention according to certain embodiments.

FIG. 11 shows dependence of scattering modulation on mid-IR power.

FIG. 12 shows averaged spectra and image intensity histograms of 100-nm, 75-nm and 50-nm PMMA particles obtained using microscopy systems of the invention according to certain embodiments.

FIG. 13 shows IR beam-shape fitting and image-area selection.

FIG. 14 shows simulated temperature distribution and transient heating response in microscopy systems of the invention according to certain embodiments.

FIG. 15 shows experimental temperature response of 500-nm PMMA particles.

FIG. 16 shows AFM characterization of single IgM molecules.

FIG. 17 shows fingerprinting of bulk IgM using microscopy systems of the invention according to certain embodiments.

FIG. 18 shows synthetic procedure of PMMA-FITC beads.

FIG. 19 shows single-particle region-of-interest (ROI) selection for spectral analysis using microscopy systems of the invention according to certain embodiments.

FIG. 20 shows spectral processing with microscopy systems of the invention according to certain embodiments.

### DETAILED DESCRIPTION

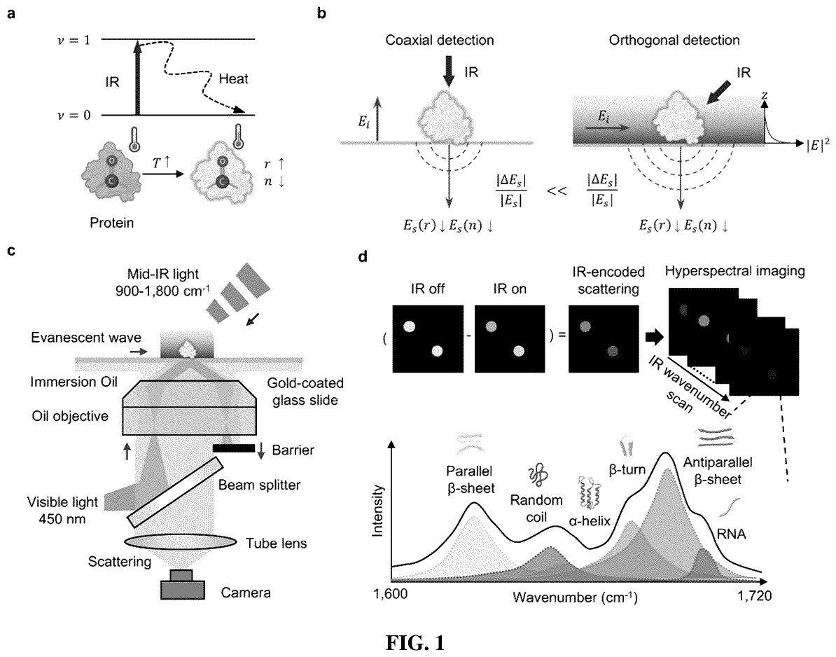

The disclosed systems and methods build on the photothermal principle (FIG. 1a): IR excitation of molecular vibrations (e.g., protein C═O stretching) generates local heating that produces a transient temperature increase (ΔT), thermal expansion (Δr), and refractive index decrease (Δn) of the molecule. These perturbations are detected in a pump-probe scheme as a modulation of the scattering intensity (ΔI), which depends on the local probe- and pump-field intensities, while the detection sensitivity is determined by the modulation depth (ΔI/I). Earlier efforts using high-energy optical parametric oscillator (OPO) mid-IR sources and interferometric enhancement pushed mid-IR photothermal sensitivity to single ~100-nm viruses in air. However, the conventional coaxial photothermal detection (FIG. 1b, left) faces an intrinsic sensitivity limit: the scattering changes induced by Δr and Δn have opposite contributions that partially cancel, suppressing the detectable modulation depth. Thus, breaking the single-molecule barrier requires a more efficient photothermal detection strategy.

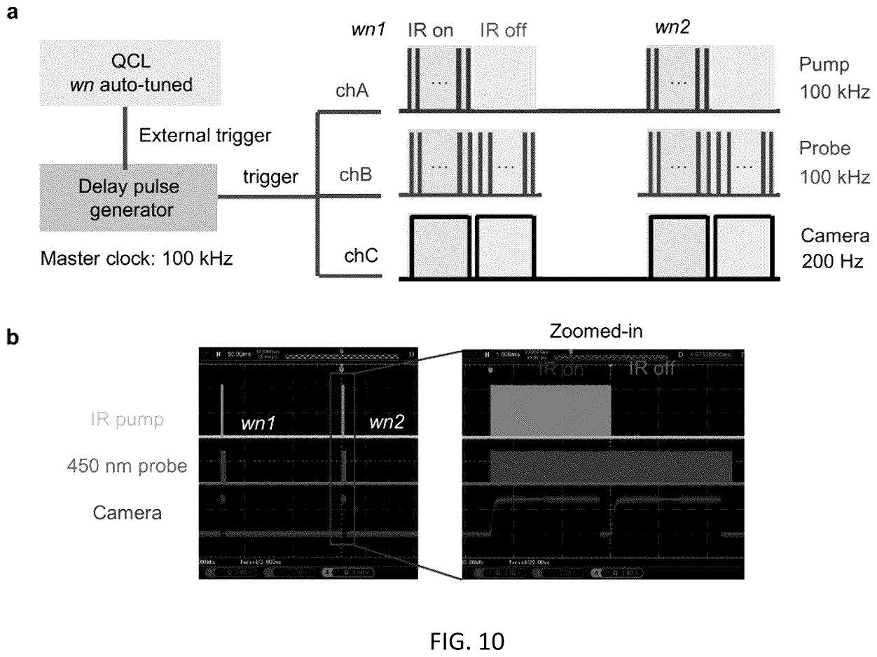

Systems and methods described herein can overcome this limitation using an orthogonal photothermal detection scheme (FIG. 1b, right, FIGS. 9 and 10). First, a surface-confined evanescent probe field enhances interferometric scattering by ~6.5-fold. Second, an IR-reflective gold-coated substrate with 45° mid-IR incidence doubles the interfacial pump field intensity. Third, the horizontally propagating evanescent wave allows scattering to be collected orthogonally, eliminating cancellation between photothermal contributions and increasing modulation depth by more than two orders of magnitude compared with coaxial detection. Together, these advances allow systems and methods herein to achieve label-free vibrational imaging of individual proteins in solution using standard quantum-cascade laser (QCL) mid-IR sources. In the examples, systems and methods described herein are validated using polymer nanoparticles to quantify sensitivity, spatial resolution, and the interferometric size dependence of the photothermal signal. Certain systems and methods of the invention are also applied to individual immunoglobulin M (IgM) molecules as a model system of single biomolecular oligomers, resolving discrete molecular counts and revealing hydration-dependent conformational heterogeneity at the single-molecule level. Extending the method to bio-nanoparticles, label-free chemical fingerprinting of individual adeno-associated virus (AAV) particles can be achieved, allowing discrimination of genomic cargo at the single-particle level. As shown in the examples, the described microscopy systems and methods can serve as a general platform for high-throughput, label-free chemical imaging of individual biomolecules and nanoscale assemblies.

In certain embodiments, to implement orthogonal photothermal detection, a visible beam can be directed onto a gold-coated glass slide under total internal reflection (TIR) using an oil-immersion objective (FIG. 1c). This configuration generates a laterally propagating evanescent field that enhances the interferometric scattering from molecules at the interface, while a spatial barrier can be used to block the reflected beam so that only the scattered light is collected orthogonally onto a camera. To encode vibrational information, a p-polarized pulsed mid-IR beam can then be synchronized to illuminate the molecule at an oblique angle (FIGS. 9 and 10). The reflective gold film doubles the local IR excitation while minimizing unwanted heating of the immersion oil. IR absorption induced photothermal effect modulates the scattering between the IR-off and IR-on frames, and subtraction of these two frames produces the IR-encoded scattering image. By scanning the IR wavenumber, hyperspectral image stacks can be generated, from which vibrational fingerprints of individual molecules can be obtained with molecular composition and structure signatures (FIG. 1d).

### Examples

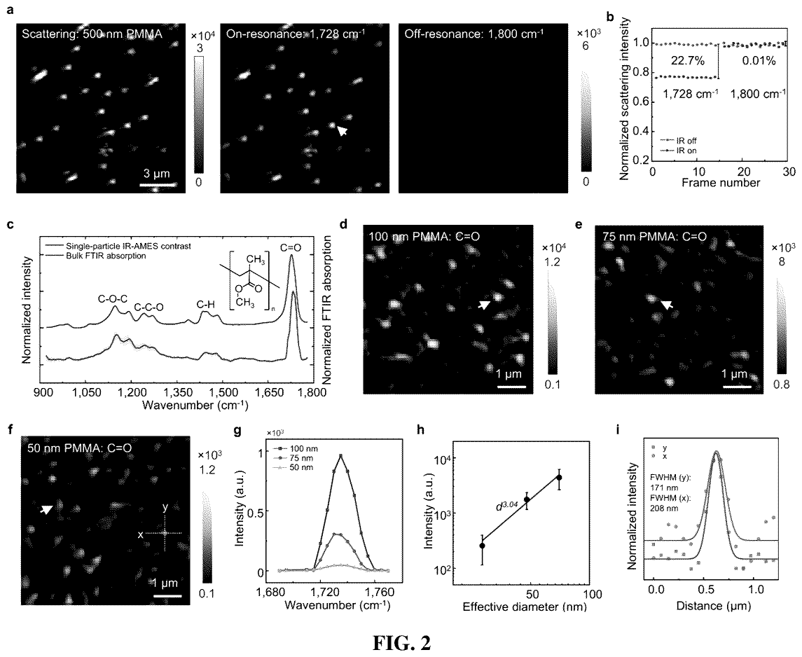

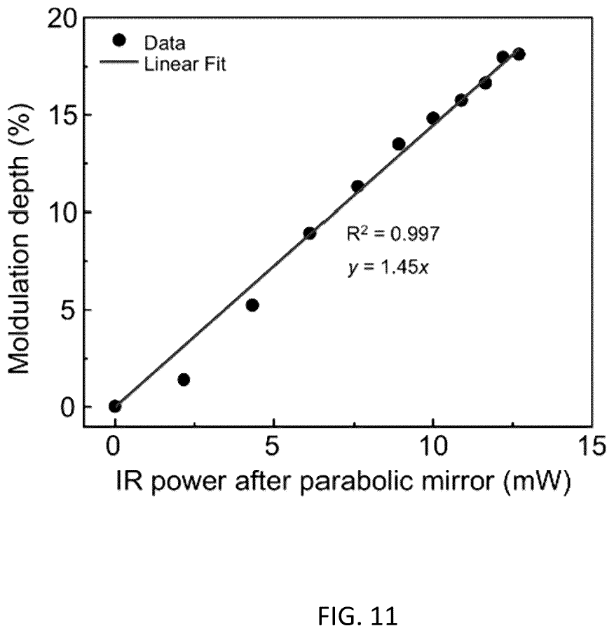

As an initial benchmark for quantitative validation, the photothermal enhancement was characterized using 500-nm poly(methyl methacrylate) (PMMA) beads, a standard testbed in scattering-based photothermal microscopy owing to their strong C═O vibrational resonance and well-defined scattering properties. These particles show bright evanescent scattering and strong IR-encoded contrast at 1,728 cm⁻¹, with negligible contrast at off-resonance state (FIG. 2a). The photothermal modulation reaches ~22.7% for a single bead (FIG. 2b) in IR-AMES, whereas coaxial photothermal detection produces only ~0.2%, a level typically buried in noise. This >100-fold enhancement enables single-shot chemical photothermal imaging at 100 Hz, with the acquisition speed limited only by the camera. The modulation depth increases linearly with IR power (FIG. 11), confirming no nonlinear thermal artifacts. Despite using a 10-fold weaker QCL pump and a 6-fold slower camera, IR-AMES achieves ~60-fold faster chemical imaging than previous interferometric IR photothermal implementations based on OPO excitation (Table 1). A hyperspectral image stack spanning 900-1,800 cm⁻¹ with a 2 cm⁻¹ step size (450 spectral points) is acquired within two minutes, primarily limited by the QCL tuning speed. The statistical spectra of 50 individual PMMA beads match FTIR results well and clearly resolve the C—O—C and C═O vibrational modes, with low spectral variation (FIG. 2c, standard deviation is 3.05×10⁻²).

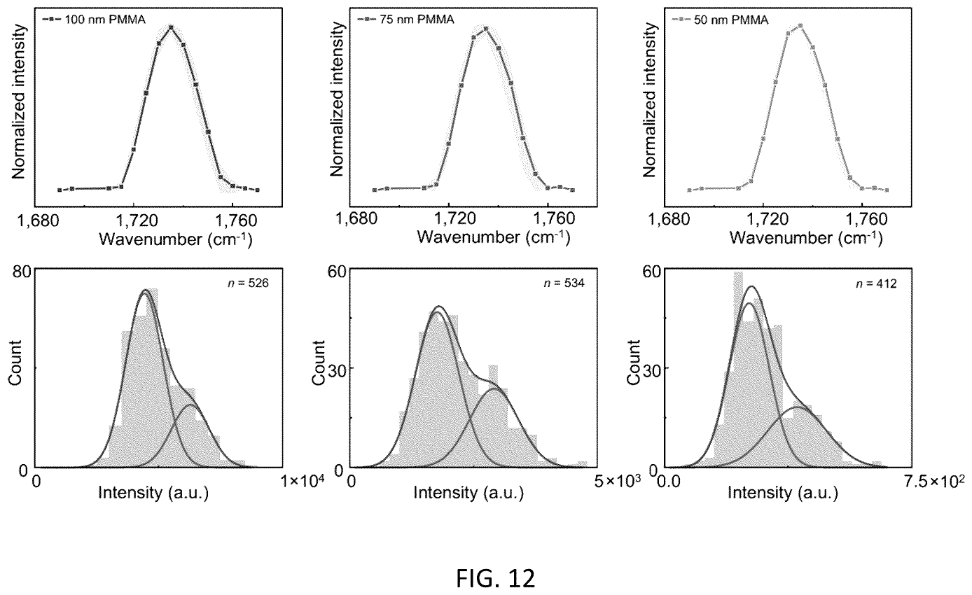

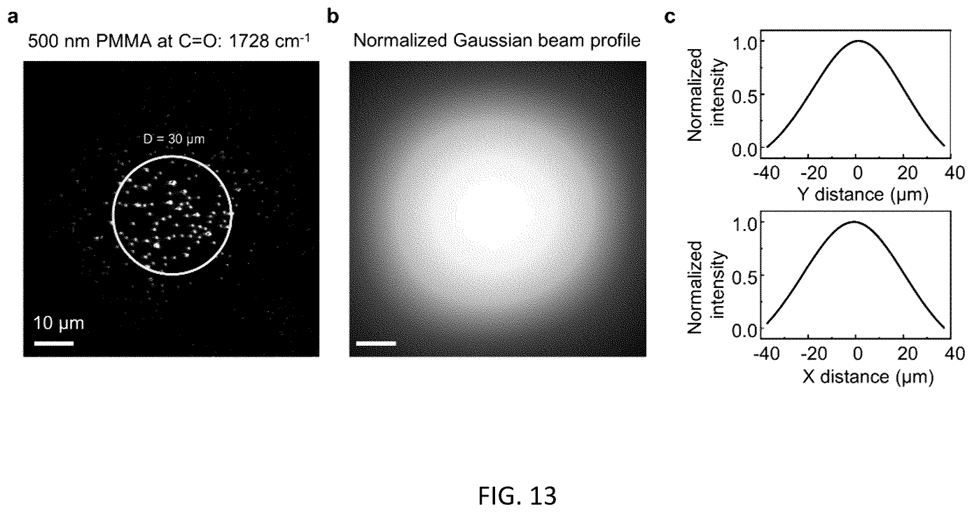

Size-dependent photothermal responses were quantified using PMMA beads of 100, 75, and 50 nm diameter (FIG. 2d-2f). The C═O peak intensity decreases with particle size, and the mean image intensity scales with the third power of diameter (FIG. 2g-2h and FIG. 12), which is due to the interferometric property. The z-distance dependence of evanescent wave is considered as effective diameter. The spatial resolution is characterized using 50-nm particles, with a spatial full width at half maximum (FWHM) of 171 nm (FIG. 2i), which breaks the IR diffraction limit with visible-light detection. IR illumination uniformity was validated by beam-profile fitting, and a central 30-μm region was selected as the effective imaging area (FIG. 13).

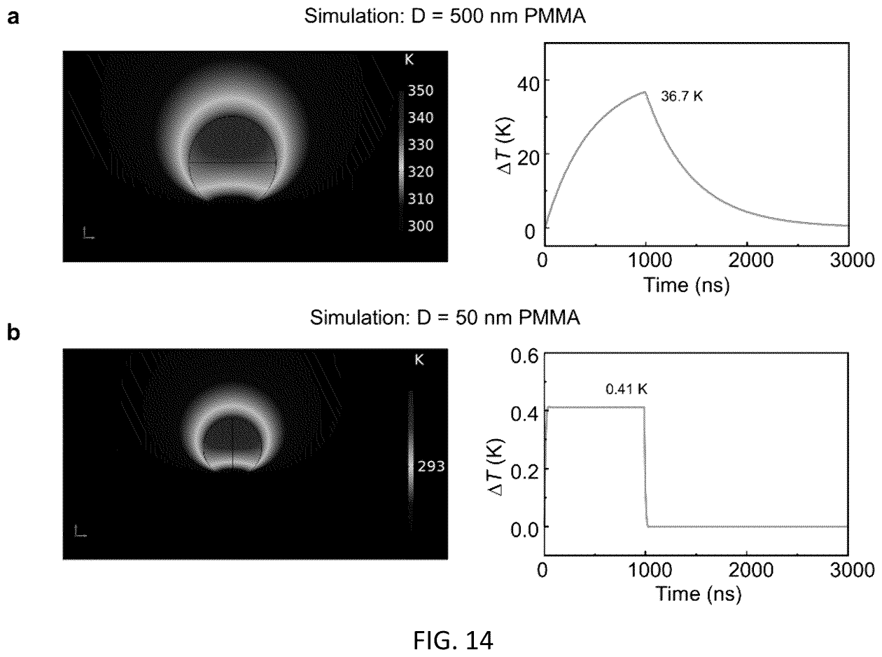

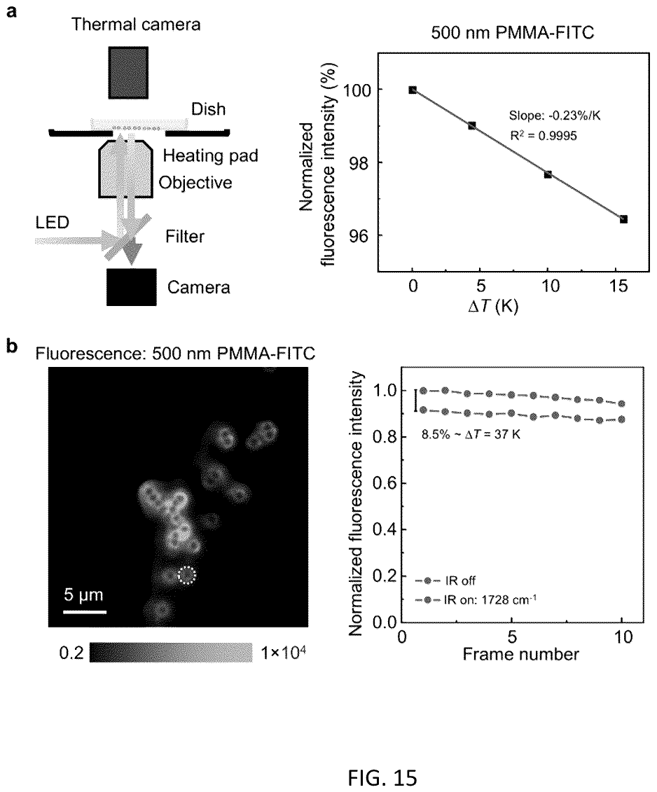

The estimated temperature rise is ~36.7 K for 500-nm PMMA and ~0.41 K for 50-nm PMMA particle (FIGS. 14 and 15), remaining within a regime compatible with biomolecular measurements. Together, IR-AMES provides a label-free, high-throughput and high-fidelity platform for quantitative vibrational spectroscopy of individual nano-objects, enabling chemical measurements at the single-protein level.

### Imaging Single-Molecule Under Native Aqueous Conditions.

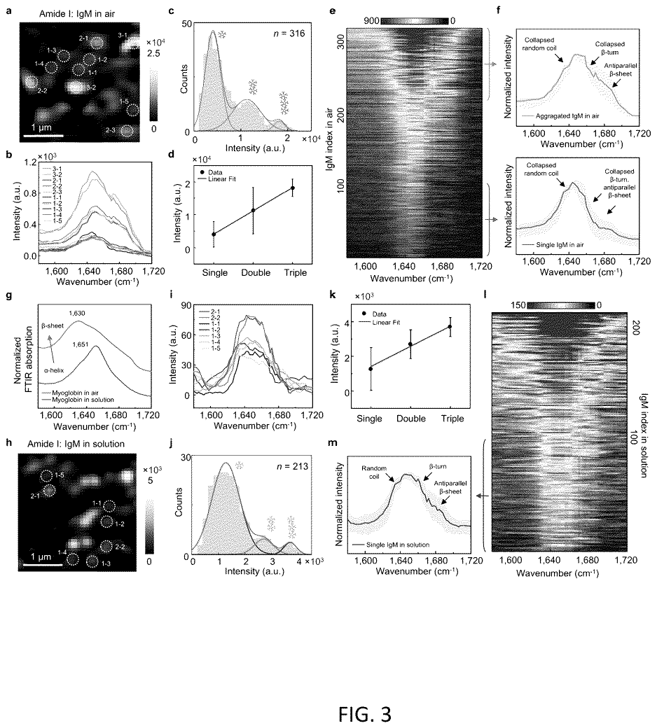

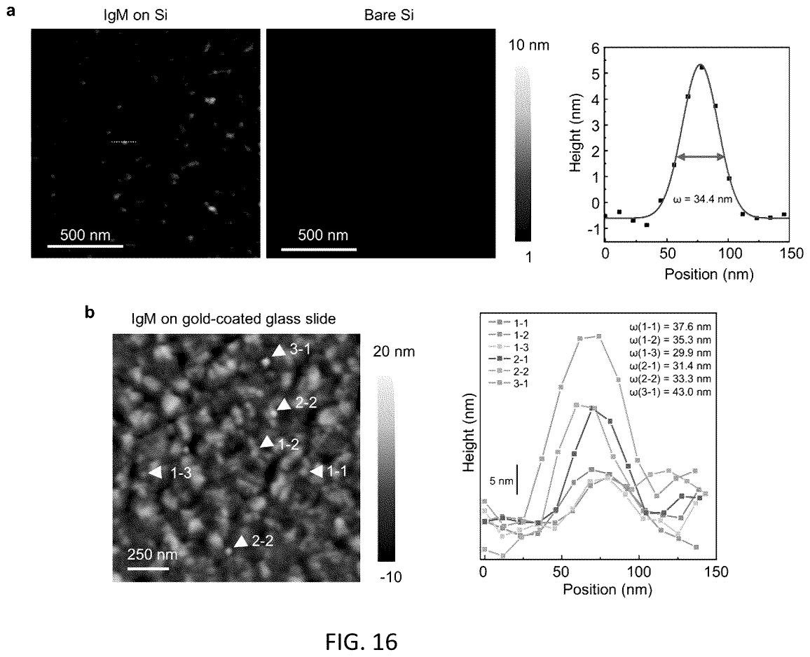

IR-AMES allows vibrational spectroscopic imaging of single biomolecules such as single proteins and single nucleic acids in a label-free manner. Towards this goal, IR-AMES was applied to IgM (~950 kDa) and focus on the amide-I band, where backbone C═O stretching is highly sensitive to protein secondary structure. IR-AMES imaging at this band resolves discrete diffraction-limited spots (FIG. 3a), and spectra extracted from these spots exhibit three quantized intensity levels (FIG. 3b), corresponding to one, two, and three IgM molecules within the detection area. Histogram analysis of ~300 particles reveals a multimodal intensity distribution (FIG. 3c). Gaussian fitting shows that the peak centers scale linearly with molecular count (FIG. 3d), confirming single-molecule detection. Atomic force microscopy (AFM) further verifies the presence of isolated IgM particles (~35 nm lateral size, ~5 nm height; FIG. 16).

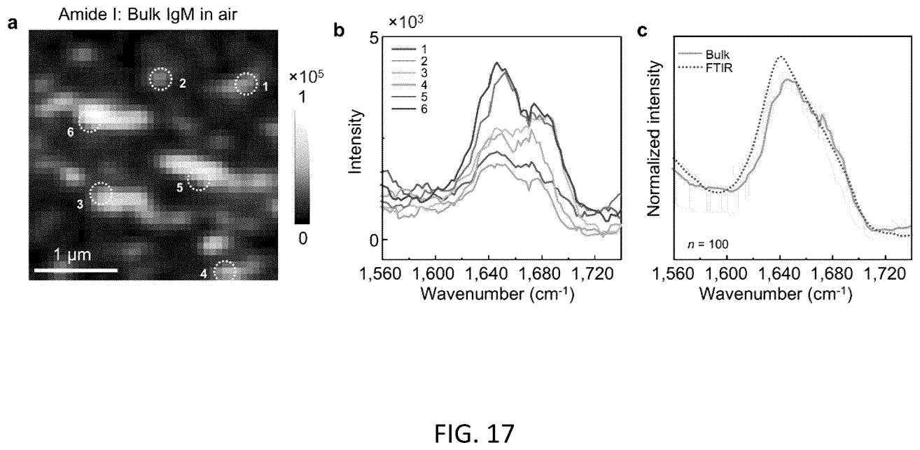

Single-particle heatmaps reveal clear conformational heterogeneity among IgM molecules, with the amide-I intensity increasing with molecular count (FIG. 3e). Spectra from single IgM molecules exhibit partially collapsed random-coil, β-turn, and antiparallel β-sheet features induced by drying (FIG. 3f, bottom), whereas small aggregates retain stronger antiparallel β-sheet signatures due to intermolecular stabilization (FIG. 3f, top). In contrast, ensemble IR-AMES and FTIR spectra of bulk dried IgM show similar spectral profile, masking this heterogeneity (FIG. 17). Control experiments on the more flexible, α-helix-dominated myoglobin show even stronger structural distortion upon dehydration, with a distinct shift toward β-sheet-rich spectra (FIG. 3g). These results highlight the need for single-molecule IR spectroscopy under native aqueous conditions, where intrinsic conformations are preserved but protein signals are easily buried by water absorption.

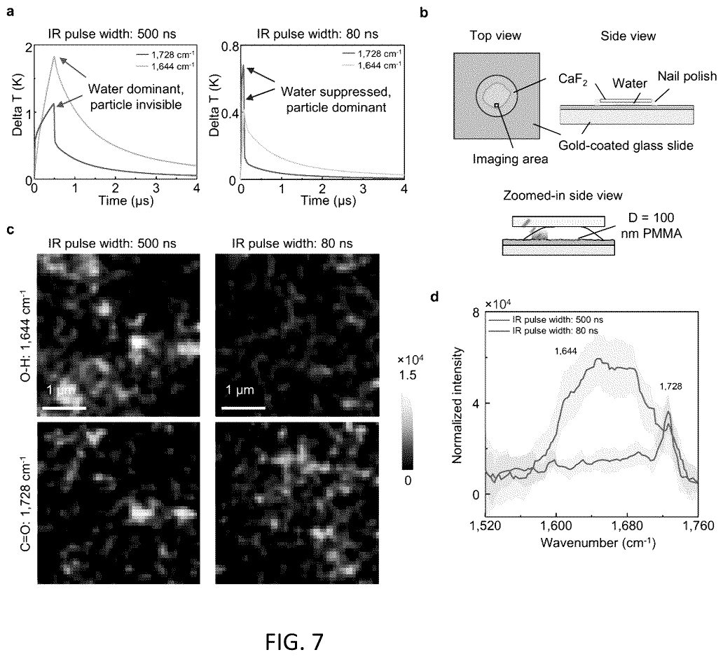

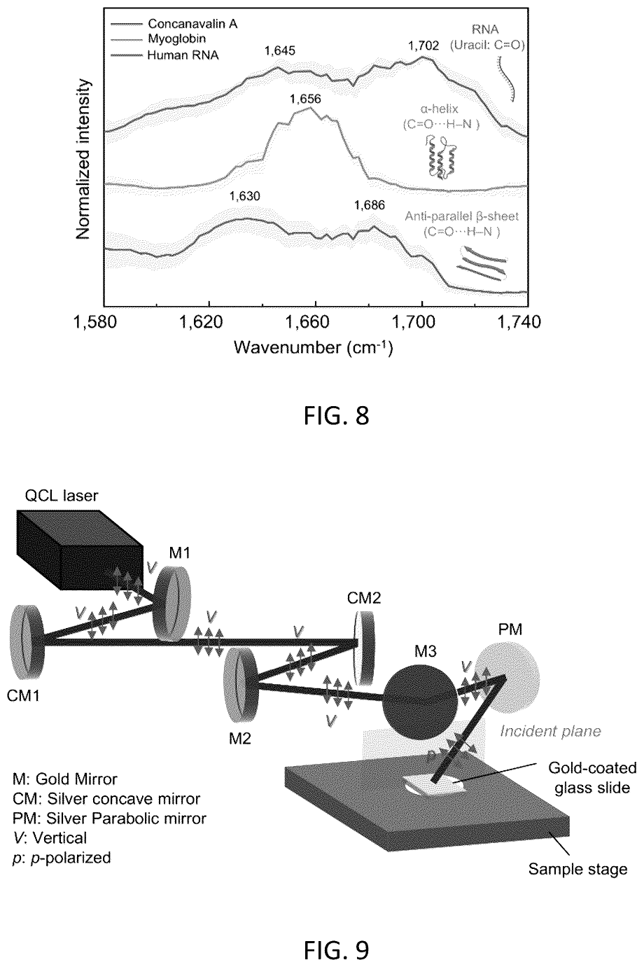

This challenge was addressed by using a thin aqueous layer (<150 nm), oblique mid-IR incidence, and short 80-ns IR pulses to confine heating to the particle and suppress water background (FIG. 7). Both simulations and measurements on 100-nm PMMA in water confirm that, under these conditions, the molecular C═O band at 1,728 cm⁻¹ dominates the photothermal response. With this strategy, IR-AMES detects hydrated IgM molecules at single-protein sensitivity (FIGS. 3h-3i). The intensity distribution is dominated by the lowest-intensity population, showing that most detected events correspond to individual IgM molecules rather than small aggregates (FIGS. 3j-3k). Hydrated IgM spectra also exhibit a broader amide-I band than in the dried state, reflecting stabilization of flexible random-coil, β-turn, and antiparallel β-sheet structures by hydration (FIGS. 3l-3m). Distinct spectral signatures are also reproduced for reference biomolecules with known structures, including α-helix, antiparallel β-sheet, and RNA components, demonstrating chemical specificity (FIG. 8, Table 2). This demonstrates the capability of IR-AMES to resolve structure of single protein in solution.

### Fingerprinting the Content of Single Bionanoparticles.

IR-AMES allows for label-free chemical fingerprinting of individual bio-nanoparticles with nanoscale dimensions, low molecular content, and heterogeneous compositions. The technique is broadly applicable to a wide range of bio-nanoparticles, including but not limited to viruses, gene delivery vectors (such as viral vectors and non-viral vectors), extracellular vesicles, and other nanoscale biological assemblies. The following example is provided as a representative embodiment to illustrate the capability of IR-AMES for single-particle chemical analysis and is not intended to limit the scope of the invention.

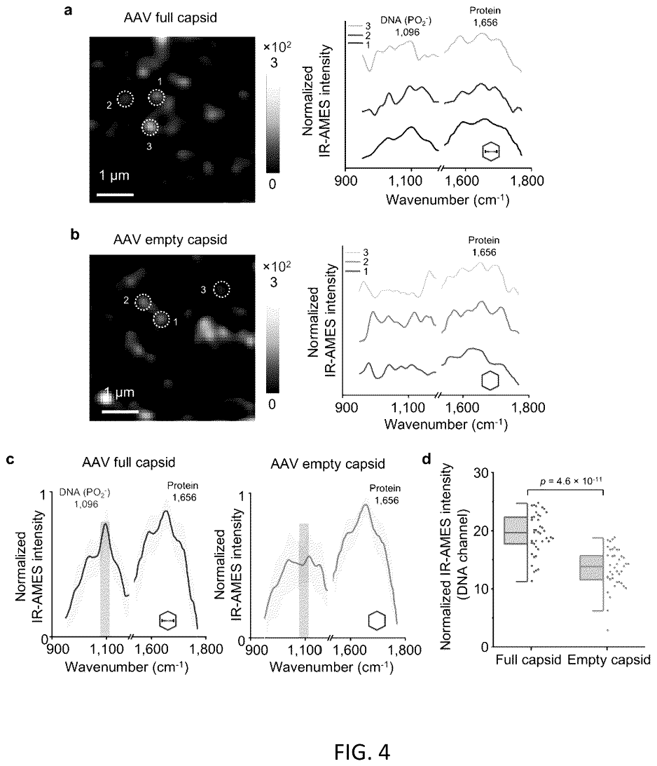

As a representative demonstration, IR-AMES is applied to fingerprint individual AAV particles, which have effective sizes down to approximately 26 nm and a genomic capacity of ~4.7 kb single-stranded DNA. IR-AMES imaging at amide-I band resolves individual AAV particles and allows extraction of single-particle vibrational spectra. Full AAV capsids (FIG. 4a) exhibit pronounced DNA-associated phosphate vibrations near 1,096 cm⁻¹ together with protein-associated amide bands, whereas empty capsids (FIG. 4b) show strongly reduced DNA signatures while retaining protein features. Ensemble-averaged spectra from multiple particles (FIG. 4c) further confirm the distinct spectral differences between full and empty capsids. Quantitative analysis of the DNA-associated vibrational band reveals a significant reduction in normalized IR-AMES intensity for empty capsids compared with full capsids (FIG. 4d), enabling direct discrimination of cargo loading states at the single-particle level. Notably, detectable DNA signals in a subset of empty capsids indicate residual nucleic acids, highlighting the sensitivity of IR-AMES to partial genome loading and compositional heterogeneity among individual bio-nanoparticles.

### Exemplary IR-AMES Setup

In various embodiments an IR-AMES system can be built on an inverted microscope frame (IX70, Olympus) and integrate a TIR visible probe with widefield mid-IR photothermal excitation. The visible probe light can be provided by a lab-built nanosecond pulsed 450-nm laser (K450F03FN-2.6W, Advanced Circuits Inc). The beam can be conditioned by an achromatic doublet lens pair (AC254-030-A-ML and AC508-180-A-ML, Thorlabs) and focused on the back focal plane of an oil-immersion objective (UPLAPO60XOHR, 60×, NA 1.50, Olympus). A three-axis translation stage (PT3, Thorlabs) may be used to adjust the incident angle and achieve TIR in air or aqueous environments. The collimated probe can be directed onto the gold-coated glass slide via the objective, and the evanescent scattering from nanoparticles on the surface may be collected by the same objective with a beam splitter (BSW10R, Thorlabs) for separating illumination and detection paths. A barrier can be placed near the back focus plane of the objective to block the reflected light and only the scattering light reaches to a CMOS camera (BFS-U3-20S4M-C, FLIR). The mid-IR pump light can be provided by a pulsed QCL laser (MIRcat 2400, Daylight Solutions), tunable from 900 to 1,800 cm⁻¹. For the wide-field photothermal imaging, the IR beam can be p-polarized and weakly focused onto the sample at a 450 incidence angle using an off-axis parabolic mirror (MPD124-P01, Thorlabs) (FIG. 9). The IR beam can be expanded by five-fold using two concave mirrors (CM254-50-P01 and CM254-250-P01, Thorlabs) to match the parabolic mirror aperture. IR power can be monitored using a power meter (PM16-401, Thorlabs) for spectra normalization.

System timing can be controlled by a four-channel delay pulse generator (9254, Quantum Composers), which provides a 100-kHz master clock to synchronize the pump pulses, probe pulses, and camera exposure (FIG. 10). The IR pulse train may be electronically chopped at 50% duty cycle, with pulse widths of 1 μs for measurements in air and 40-80 ns (80 ns for PMMA beads, 40 ns for biomolecules) for measurements in aqueous environments. The camera can record IR-on and IR-off frames sequentially, and IR-encoded scattering images may be generated by two-frame subtraction at each wavenumber. For hyperspectral imaging, the QCL can operate in “Step-and-Measure” mode and send a start-of-scan trigger at each wavenumber, which is received by the delay generator as an external trigger to initiate the pump-probe-camera sequence. This acquisition cycle can repeat at every spectral step until the scan reaches the final wavenumber, with a dead interval of ~250 ms between adjacent steps. The estimated power density at the sample plane is then ~0.1-6 kW/cm² for the visible probe and ~0.05-1.5 kW/cm² for the mid-IR pump, depending on the pulse width and effective illumination area. The probe light intensity and camera exposure time can be optimized for each measurement (Table 3).

### Sample Preparation

For PMMA nanoparticle detection, PMMA beads were diluted 100-1000 times in deionized (DI) water and then spin-coated onto gold-coated glass slides, and dried in air. For measurements in aqueous environments, the dried PMMA-coated substrates were gently rinsed with DI water to remove loosely attached particles. A small volume of DI water (<0.1 μL) was added onto the surface and sealed with a CaF₂ coverslip to form a thin aqueous layer (<150 nm at the edge) for IR-AMES imaging. For IgM detection in air, IgM was diluted to 1 nM in PBS and incubated on a cleaned gold-coated coverslip for >1 h in 4° C. to allow unspecific binding. The surface was gently rinsed with PBS and DI water to remove unbound molecules, then dried in air before IR-AMES imaging. For IgM detection in solution, IgM was prepared and adsorbed as above, followed by a gentle PBS rinse. A small volume of PBS (<0.1 μL) was added and sealed with a CaF₂ coverslip to form a thin aqueous layer (<150 nm at the edge) for IR-AMES measurements. Sample preparation for viral vectors imaging followed the same procedure used for IgM measurements in air.

### Data Processing

IR-AMES imaging data were acquired with custom MATLAB scripts and analyzed with ImageJ. Data plotting and statistical analysis were performed in Origin. Pseudocolor was added to the IR-AMES and fluorescence images with ImageJ. Spectral analysis of single-particle spectra was performed in MATLAB. Detailed image and spectral analysis workflows are described below. Protein illustrations and structural schematics were created with BioRender.

### AFM Imaging

All AFM experiments were carried out in air using AC/tapping mode with a soft tapping mode tip (2 N/m) (240AC-NA-10, Nanoandmore USA) with the scan rate of 1.0 Hz with with the Asylum AFM Cypher S/ES instrument.

### FTIR Measurement

The FTIR spectra were acquired using an attenuated total reflection FTIR spectrometer (Nicolet Nexus 670, Thermo Fisher Scientific). The spectra resolution is 2 cm⁻¹ and each spectrum was measured with 128 scanning. Baseline correction and spectral normalization were applied using the instrument software.

FIG. 1 illustrates exemplary IR-AMES concept and implementation. FIG. 1a shows the photothermal principle. An infrared (IR) laser excites molecular vibrations from ground state (v=0) to excited state (v=1). Subsequent non-radiative relaxation generates localized heating, leading to a transient increase in temperature (T), thermal expansion of the protein radius (r), and a decrease in refractive index (n). FIG. 1b illustrates exemplary detection geometries. Conventional coaxial interferometric photothermal detection (left) can identify ~100-nm particles but suffers from partial cancellation between photothermal-induced changes in r and n, limiting sensitivity. In contrast, IR-AMES can use a squeezed, horizontally propagating evanescent probe and collects its scattering orthogonally (right). With oblique IR excitation and gold-film enhancement, this geometry avoids the cancellation and produces much stronger photothermal-induced scattering modulation. Ei: incident light, ES: scattered light from the sample.

FIG. 1c shows an exemplary schematic of an IR-AMES setup. A visible probe laser undergoes total internal reflection at the gold-coated glass slide to generate a surface-confined evanescent field. A barrier blocks the reflected beam, and the evanescent scattering is collected orthogonally through an oil objective onto a CMOS camera. A pulsed mid-IR pump laser is introduced at an oblique angle to excite molecular vibrations, while the gold film enhances IR confinement.

FIG. 1d shows an exemplary image-processing workflow. IR-encoded scattering images are generated by subtracting IR-off from IR-on frames. Scanning the IR wavenumber produces hyperspectral stacks, from which molecular composition and structure signatures are extracted for individual particles.

FIG. 2 shows exemplary IR-AMES performance. FIG. 2a illustrates an evanescent scattering image of single 500-nm PMMA particles at the IR-off state, and corresponding IR-AMES images at on-resonance (1,728 cm⁻¹, C═O band) and off-resonance (1,800 cm⁻¹). Scale bar: 3 μm. FIG. 2b shows scattering modulation at on- and off-resonance of the PMMA particle indicated by the white arrow in FIG. 2a. FIG. 2c shows spectral fidelity of IR-AMES from 500 nm PMMA beads (n=50). Black solid line: FTIR spectrum, gray solid line: mean spectra, shaded region: standard-deviation. The average standard deviation from is 3.05×10⁻². Inset: molecular structure of PMMA. FIGS. 2d-2f show IR-AMES images of 100-nm (d), 75-nm (e) and 50-nm (f) PMMA particles, integrated over the C═O band (1,715-1,755 cm⁻¹). Scale bars: 1 μm. FIG. 2g shows representative C═O spectra from single particles marked by white arrows in FIGS. 2d-2f. FIG. 2h shows IR-AMES image intensity versus effective particle diameter (d) under the evanescent field. The image intensity at the center of error bar for each diameter is obtained from the mean value of the corresponding histogram shown in FIG. 12. The error bars indicate the full width at half maximum (FWHM) of the Gaussian fitting of corresponding histograms. FIG. 2i shows spatial resolution of IR-AMES, with the FWHM obtained from the white dashed cross in FIG. 2f. Solid lines: Gaussian fitting results.

FIG. 3 shows fingerprinting of single proteins under native conditions. In FIGS. 3a-3f show IgM is in air. FIG. 3a shows an IR-AMES image of IgM molecules at the amide I band (1,620-1,660 cm⁻¹). Scale bar: 1 μm. FIG. 3b shows representative single-particle spectra extracted from circled IgM molecules in FIG. 3a, showing increased amide-I intensity.

FIG. 3c shows image intensity histograms of IgM molecules with Gaussian fittings. Secondary and tertiary peaks correspond to multi-molecule binding or multiple molecules within sub-diffraction distances. FIG. 3d shows IR-AMES intensity versus IgM molecule count. Data points represent the mean of each peak in FIG. 3c. Error bars indicate fitted Gaussian FWHM. FIG. 3e is a heatmap of single-particle spectra in the amide-I region, sorted by integrated intensity over amide I band. FIG. 3f shows representative average spectra for aggregated IgM (index 217-316) and single IgM (index 1-100) in air. Solid line: mean spectra, shaded region: standard-deviation.

FIG. 3g shows drying-induced distorts of native myoglobin secondary structures, with FTIR spectra shifting from α-helix (solution, 20 mg/ml) to β-sheet (air, crystal). In FIGS. 3h-3m, IgM is in solution. FIG. 3h shows an IR-AMES image of IgM molecules at the amide I band. Scale bar: 1 μm. FIG. 3i shows representative single-particle spectra extracted from circled IgM molecules in FIG. 3h. FIG. 3j shows image intensity histograms of IgM molecules with Gaussian fittings. Secondary and tertiary peaks indicate multi-molecule binding events or multiple molecules within sub-diffraction distances. FIG. 3k shows IR-AMES image intensity versus IgM molecule count extracted as in FIG. 3d. FIG. 3l shows a heatmap of single-particle spectra of IgM, sorted by integrated intensity over amide I band. FIG. 3m shows representative average spectra for single IgM molecules in solution (index 1-100) in FIG. 3l. Solid line: mean spectra, shaded region: standard-deviation.

FIG. 4 shows label-free fingerprinting of single AAV particles by IR-AMES. FIGS. 4a and 4b show IR-AMES images of individual AAV full capsids (a) and empty capsids (b) at protein band (1,650 cm⁻¹), with representative single-particle spectra extracted from selected particles. FIG. 4c shows ensemble-averaged spectra of AAV full capsids (left) and empty capsids (right) (n=41 particles per group). The DNA-associated phosphate band near 1,096 cm⁻¹ is distinct in full capsids and reduced in empty capsids, while protein-associated bands near 1,656 cm⁻¹ are present in both populations. Shaded regions indicate spectral variability. FIG. 4d shows a quantitative comparison of the normalized IR-AMES intensity of the DNA-associated phosphate band for individual full and empty capsids, showing a significant reduction in empty capsids.

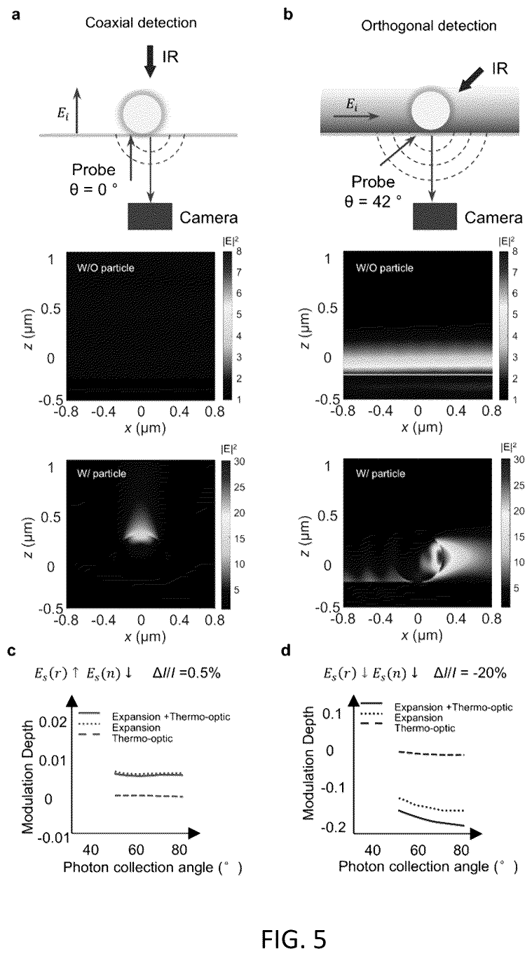

FIG. 5 shows a numerical comparison of probe-field intensity and photothermal modulation in coaxial versus orthogonal-evanescent detection. FIGS. 5a and 5b show detection geometries and simulated probe-field intensity distributions (with and without a 500-nm PMMA particle) at the substrate-air interface for conventional coaxial interferometric photothermal detection (a) and orthogonal-evanescent photothermal detection (b). In the orthogonal-evanescent configuration, the evanescent field propagates laterally along the interface and decays exponentially with distance from the surface. This surface confinement increases the local probe intensity by ~6.5-fold. The incident light intensity: |E₀|²=1. FIGS. 5c and 5d show calculated photothermal modulation depths for coaxial detection (c) and orthogonal-evanescent detection (d), showing partial cancellation between expansion and thermo-optic effects in the coaxial geometry and strong modulation in the orthogonal-evanescent configuration.

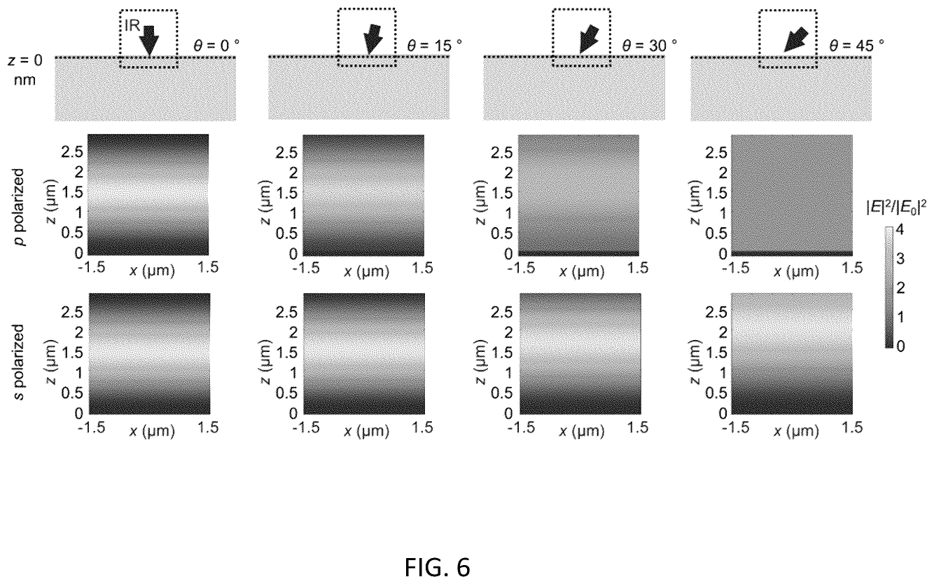

FIG. 6 shows simulated IR field intensity on a gold-coated substrate at different incident angles (θ). The IR wavelength corresponds to the C═O vibrational band (1,728 cm⁻¹). Images show the normalized field intensity |E|² in the xz plane for both p- and s-polarized excitation. The incident light intensity: |E|²=1.

FIG. 7 shows a water-suppression strategy allowing IR-AMES detection of nanoparticles in aqueous environments. FIG. 7a shows simulated thermal decay of a 100-nm PMMA nanoparticle in water. A long IR pulse (500 ns) produces strong water absorption at the O—H band (1,644 cm⁻¹), making the PMMA C═O band (1,728 cm⁻¹) invisible. A short 80-ns pulse confines heating to the particle, suppresses water absorption, and makes the bead signal dominant. FIG. 7b shows a schematic of IR-AMES imaging in liquid environment with thin water layer (<150 nm) and oblique IR incidence at the edge. FIG. 7c shows IR-AMES images of 100-nm PMMA nanoparticles in water with 500-ns and 80-ns IR pulses. The average mid-IR power at the sample plane was 11.8 mW (500 ns) and 2.7 mW (80 ns) at 1,728 cm⁻¹, and 15.5 mW (500 ns) and 3.5 mW (80 ns) at 1,644 cm⁻¹. Scale bars: 1 μm. FIG. 7d shows averaged IR-AMES spectra showing that under 80-ns IR excitation, the water background is suppressed and the PMMA peak appears. Solid lines: mean spectra, shaded regions: standard-deviation. (500 ns: n=17; 80 ns: n=13).

FIG. 8 shows IR-AMES spectral peak assignment of reference biomolecules in solution. Representative IR-AMES spectra of Concanavalin A, myoglobin, and human reference RNA in solution, showing characteristic vibrational features assigned to antiparallel β-sheet (~1,686 cm⁻¹), α-helix (~1,656 cm⁻¹), and RNA uracil C═O stretching (~1,702 cm⁻¹). Solid lines: mean spectra, shaded regions: standard-deviation (n=40 for each).

### Electromagnetic Simulations of Probe-Field Intensity, Photothermal-Induced Scattering Modulation Depth, and Mid-IR Field Enhancement.

Electromagnetic simulations were performed to (i) quantify the visible probe-field distribution under total internal reflection, (ii) estimate the photothermal-induced scattering modulation depth, and (iii) calculate the mid-IR field intensity on the gold-coated substrate as a function of incidence angle and polarization.

To compare the probe-field intensity and photothermal modulation between conventional coaxial interferometric photothermal detection and orthogonal-evanescent detection in IR-AMES, electromagnetic simulations were carried out using COMSOL Multiphysics 6.0. A PMMA particle with diameter d_{PMMA} of 500 nm was positioned at the interface of air and gold-coated glass. The contact region between the particle and substrate was modelled as a circular area with a diameter of 0.4d_{PMMA}. The refractive index of PMMA and glass were set to 1.4998 and 1.5253, respectively. The gold film was modelled with a thickness of 50 nm, using the dielectric function reported by Olmon et al.

Transient temperature evolution was first calculated using the Heat Transfer in Solids physics module. The heat source was confined to the PMMA particle and defined by an absorption cross-section of 4.64×10⁻¹⁰ cm², driven by a 1 μs square heating pulse with a peak power of 0.4 W. The resulting temperature distribution and temporal dynamics were exported to the electromagnetic simulation to account for thermally induced optical perturbations. The scattering-field modulation induced by photothermal effects was modelled using the Electromagnetic Waves module, incorporating both thermo-optic refractive-index changes and thermal expansion of the particle. The probe field was defined as a 450 nm plane wave incident from the glass substrate. For the orthogonal evanescent configuration, the incidence angle was set to 42°, corresponding to total internal reflection, whereas normal incidence was used for the coaxial configuration. Periodic boundary conditions were applied to the lateral boundaries of the simulation domain to emulate an extended interface. The simulation domain was surrounded by perfect matched layer to reduce back-reflections. The power flow of the scattered field was integrated on a surface located 1.2 μm away from the particle, within an 80° collection cone, with a barrier blocking the reflection path to replicate the numerical aperture of the experimental objective. The scattering cross-section σ_{scat} was obtained by dividing the obtained integral with the intensity of the incident wave. Photothermal modulation of σ_{scat} was evaluated by perturbing (i) the refractive index of PMMA using a thermo-optic coefficient ~1×10⁻⁴K⁻¹, and (ii) the particle size using a thermal expansion coefficient 1×10⁻⁴K⁻¹ scaled by the simulated temperature rise (FIG. 5).

Mid-IR field distributions were simulated using Ansys Lumerical FDTD Solutions (v2024 R2.1). The model consisted of a 50-nm-thick gold film on a glass substrate, with air above the film. A monochromatic plane wave at 1,728 cm⁻¹, corresponding to the PMMA C═O vibrational band, was introduced using a total-field scattered-field source propagating along the z axis toward the substrate. To study the dependence of the field distribution on illumination geometry, simulations were performed for incident angles θ=0°, 15°, 30°, and 45° within the x-z plane. Polarization was controlled by the source polarization angle: 0° for p polarization (electric field in the plane of incidence) and 90° for s polarization (electric field perpendicular to the plane of incidence). The incident field amplitude was set as |E₀|²=1. Perfectly matched layers were applied on all boundaries. The spatial distribution of the electric-field intensity was recorded using a frequency-domain 2D profile monitor, providing x-z maps of the normalized field intensity |E_{IR}|²/|E₀|² above the gold surface (FIG. 6).

### Correction of Effective Diameter in the Evanescent Field.

The evanescent field decreases exponentially at z-direction from the surface into the medium³, the penetration depth (l) of the evanescent field can be calculated by

$$l = \frac{λ}{4 π} {( {n}_{1}^{2} sin θ - {n}_{2}^{2} )}^{- 1 / 2}$$

where λ=450 nm is the probe light wavelength, θ is the incident angle, n₁=1.5253 and n₂=1.00028 are the refractive index of the glass substrate and air medium at 450 nm, respectively. l=176.6 nm when θ is set as 42°.

The scattering of the evanescent field by a nanoparticle depends on the distance (z) from the surface⁴. For particles with different sizes, the effective scattering diameter D_{eff} and volume V_{eff} of the particle can be given by

$${V}_{eff} = \frac{4 π}{3} {( \frac{{D}_{eff}}{2} )}^{3} = {\int }_{0}^{D} π ( D z - {z}^{2} ) {e}^{- \frac{z}{t}} d z$$

where D is the diameter of the particle. Taking this z-distance dependence into account, the effective diameters of 100, 75, 50 nm PMMA nanoparticles used in FIG. 2 should be 70.0, 47.7, 28.2 nm, respectively.

### Simulation of the Temperature Rise.

To quantitatively understand the photothermal heating process in IR-AMES, time-dependent thermal simulations were performed using COMSOL Multiphysics 6.0 based. The thermal diffusion under mid-IR excitation was simulated via the heat-transfer-in-solids module by solving the heat diffusion equation:

$${C}_{p} ρ \frac{\partial T}{\partial t} + ∇ \cdot ( - k ∇ T ) = Q ( t )$$

where Q (t) represents the volumetric heat source arising from infrared absorption, T is the temperature, t is the time, Cₚ is the heat capacity, ρ is the density, and k is the thermal conductivity of the material in the system.

For simulations in air (FIG. 14), a single PMMA bead (diameter 500 nm or 50 nm) was placed on a 50-nm-thick-gold-coated glass substrate. The IR excitation was set to the PMMA C═O resonance at 1,728 cm⁻¹. The IR illumination was modeled as an elliptical beam with a semi-major axis a=25 μm and semi-minor axis b=22.85 μm, as measured experimentally (FIG. 13). The average IR power was set to 20 mW and calibrated by the absorption cross section of PMMA at the selected wavenumber. The pulse repetition rate was 100 kHz with a pulse width of 1 μs. To consider reflective enhancement from the gold film, an IR field enhancement factor of 2 was applied. The initial temperature and all thermal boundaries were set to 298 K. Heat convection was neglected. The heat source term was defined within the PMMA bead volume. The simulated temperature distributions and transient heating profiles are shown in FIG. 14. The maximum temperature rise (ΔT) was calculated to be ~36.7 K for a 500-nm PMMA bead and ~0.41 K for a 50-nm bead under these conditions.

For simulations in aqueous environments (FIG. 7a), a 100-nm PMMA bead was placed on the same gold-coated substrate and covered by a 110-nm-thick water layer. Simulations were performed at both the PMMA C═O band (1,728 cm⁻¹) and the water O—H bending band (1,644 cm⁻¹). The average IR powers were set to 11.8 mW (500 ns) and 2.7 mW (80 ns) at 1,728 cm⁻¹, and 15.5 mW (500 ns) and 3.5 mW (80 ns) at 1,644 cm⁻¹. The simulated temperature profiles (FIG. 7a) show that long IR pulses (500 ns) induce strong bulk water heating, which overwhelms the particle signal. In contrast, short IR pulses (80 ns) confine heating to the nanoparticle, strongly suppress water absorption.

### Experimental Validation of Temperature Response.

To experimentally validate the temperature response under mid-IR heating in IR-AMES, fluorescence thermometry was performed using 500-nm PMMA beads labeled with fluorescein isothiocyanate isomer I (PMMA-FITC). PMMA-FITC beads were synthesized by reacting amine-functionalized PMMA beads with FITC via its isothiocyanate group (Supplementary FIG. 10).

Temperature calibration was performed using widefield epi-fluorescence microscopy (IX71, Olympus, FIG. 15a). PMMA-FITC beads were dispersed in a glass-bottom dish in air and placed on a temperature-controlled heating pad, while the sample temperature was monitored by a thermal camera (FLIR A325sc). Fluorescence images were acquired using an air objective (Plan Fluor 20×/0.50, AmScope) and a scientific CMOS camera (ORCA-Flash4.0 V3, Hamamatsu; exposure time 5 s). The normalized fluorescence intensity decreases linearly with temperature increase, with a calibration slope of −0.23%/K (R²=0.9995).

To quantify the photothermal temperature rise under IR-AMES, the 500-nm PMMA-FITC beads were dispersed on a gold-coated glass slide and imaged at the single-particle level in the system. Fluorescence images were recorded with an exposure time of 45 ms (gain 30, frame rate 12.5 fps). The visible probe was the same light used in IR-AMES measurements, with a neutral-density filter applied to attenuate fluorescence excitation intensity and minimize photobleaching. Fluorescence detection was performed using a 490-nm long-pass dichroic mirror (DMLP490R, Thorlabs), a 500-nm short-pass excitation filter, and a 500-nm long-pass emission filter. The mid-IR pump laser operated at 100 kHz with a pulse width of 1 μs and was tuned to the PMMA C═O resonance (1,728 cm⁻¹). Under IR-on conditions, the fluorescence intensity of individual PMMA-FITC beads decreased by ~8.5% relative to IR-off frames (FIG. 15b). Thus, the observed fluorescence modulation corresponds to a local temperature rise of approximately 37 K for 500-nm PMMA beads in IR-AMES detection, which matches the simulation well (FIG. 14a). This also indicates that the orthogonal-scattering-based photothermal geometry (FIG. 2b) provides ~2.5-fold larger modulation depth than fluoresce-detected photothermal redout.

### IR-AMES Image and Spectral Processing Workflow.

IR-AMES images can be generated by subtracting the scattering image at IR-off from IR-on frames at each wavenumber (FIG. 1d). In various embodiments the resulting images and spectra can be processed as described below.

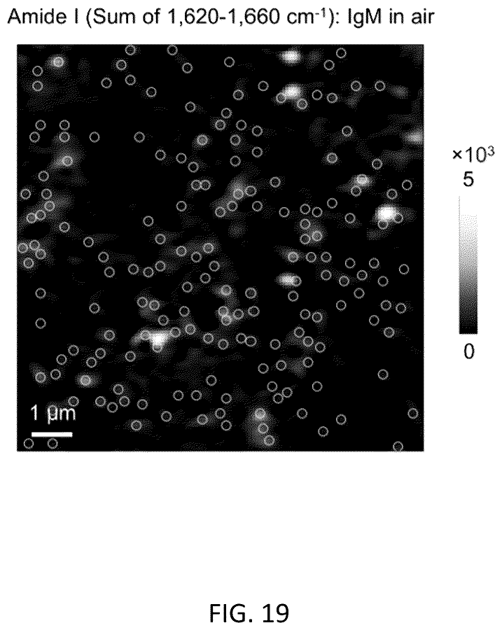

IR-AMES images were denoised using a band-pass filter in ImageJ. Individual nanoparticles were automatically identified using TrackMate plugin in ImageJ with a fixed spot diameter of 3 pixels (~225 nm, camera pixel size 75 nm), corresponding to the diffraction-limited spot size (FIG. 19). For particles larger than the diffraction limit, such as 500-nm PMMA beads, their physical size was used for particle selection. For each identified particle, IR-AMES spectra were extracted by averaging the pixel intensities within the selected region at each wavenumber.

Extracted spectra were baseline-corrected, normalized by the measured IR power at each wavenumber, and lightly smoothed (7-11 points) to suppress noise without distorting spectral features.

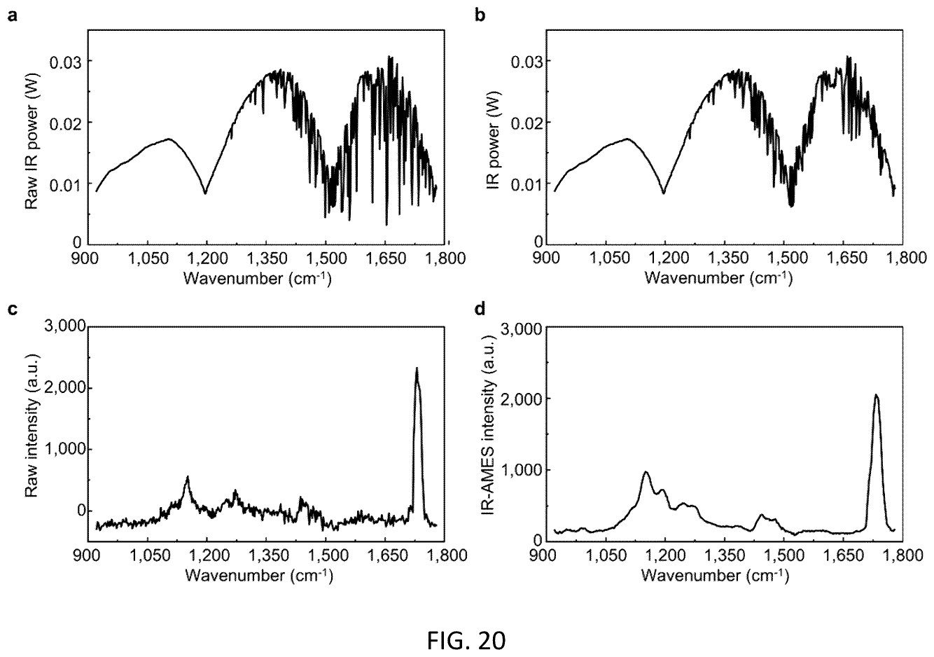

Water absorption along the IR beam path can induce sharp power dips at specific wavenumbers, resulting in abnormally low IR power (FIG. 20a). To prevent artifacts arising from normalization by these low-power points, wavenumbers strongly affected by water absorption were identified from the measured IR power spectrum and excluded from further analysis (FIG. 20b). The remaining spectra were then normalized by the corresponding IR power to correct for wavelength-dependent power variation (FIG. 20c-d). This workflow enables reliable retrieval of single-particle vibrational spectra while minimizing artifacts from water absorption, power fluctuations, and background noise.

TABLE 1
Performance of IR-AMES and widefield interferometric defocus-enhanced
mid-IR photothermal (WIDE-MIP) imaging. Comparison is performed using
500-nm PMMA beads in air at the C═O resonance 1,728 cm⁻¹.

| System | Mid-IR source | Pulse energy | Camera speed | Chemical imaging speed |
|---|---|---|---|---|
| IR-AMES | QCL laser | ~0.2 μJ | 200 fps | 100 Hz, single shot |
| | (MIRcat 2400, | | | |
| | Daylight Solutions) | | | |
| WIDE-MIP | OPO laser | ~2.5 μJ | 1250 fps | 1.56 Hz, 400 frames |
| | (Firefly-LW, M | | | averaged |
| | Squared Lasers) | | | |

TABLE 2
Peak assignment. The protein Amide I band arises mainly from
C═O stretching vibrations, with the band position determined
by the backbone conformation and the C═O•••H—N hydrogen-
bonding pattern. In contrast, the Amide II band (1,600-1,500
cm⁻¹), which originates from C—N stretching and N—H bending
vibrations, lacks structural specificity for secondary structure
analysis.

| Fitting components | Peak range (cm⁻¹) |
|---|---|
| low-frequency β-sheet | 1,615-1,634 |
| (mainly parallel) | |
| Random coil | 1,638-1,648 |
| α-helix | 1,650-1,660 |
| β-turn | 1,664-1,680 |
| high-frequency β-sheet | 1,680-1,694 |
| (mainly anti-parallel) | |
| RNA¹¹ (C═O stretching in Uracil) | 1,696-1,710 |

TABLE 3
Incident probe light intensity and camera
exposure time for different measurements.

| | Incident light | Camera exposure |
|---|---|---|
| Samples | (kW/cm²) | time (ms) |
| 500-nm PMMA particle | 0.1 | 4.5 |
| 100-nm PMMA particle | 0.15 | 9.5 |
| 75-nm PMMA particle | 0.18 | 14.5 |
| 50-nm PMMA particle | 0.6 | 14.5 |
| IgM in air | 6 | 14.5 |
| IgM in solution | 6 | 14.5 |
| AAV in air | 6 | 14.5 |

FIG. 10 shows IR-AMES signal acquisition and synchronization according to various embodiments. FIG. 10a shows a schematic of the synchronization workflow. wn: wavenumber. During QCL auto-step scanning, the start of each wavenumber step sends an external trigger to a delay pulse generator. The generator, running with a 100-kHz master clock, synchronously triggers the mid-IR pump laser (100 kHz), the 450-nm probe laser (100 kHz), and the camera (200 Hz) to synchronize the IR pump pulses, visible probe pulses, and camera exposure at each wavenumber. This sequence repeats as the QCL scans through all programmed wavenumbers. The internal trigger step time determines the IR firing window per frame and is set to match the camera exposure. The camera is triggered to acquire both one IR-on (hot) frame and one IR-off (cold) frame at each wavenumber, and the IR-AMES photothermal contrast is obtained by subtracting cold from hot frames. FIG. 10b shows oscilloscope traces showing synchronized IR pump pulses, visible probe pulses, and camera exposure pulses during wavenumber scanning.

FIG. 11 shows dependence of scattering modulation on mid-IR power. The linear relationship between scattering change and IR absorption indicates no-system-induced nonlinear effects in the measurement.

FIG. 12 shows averaged IR-AMES spectra and image intensity histograms of 100-nm, 75-nm and 50-nm PMMA particles. Top: Averaged IR-AMES spectra of PMMA particles, with solid lines showing the mean spectrum and shaded regions indicating the standard deviation. Bottom: Intensity histograms integrated over the C═O band (1,715-1,755 cm⁻¹), fitted with Gaussian components corresponding to single particles, multi-particle aggregates, or multiple particles located within sub-diffraction distances.

FIG. 13 shows IR beam-shape fitting and image-area selection. FIG. 13a shows an IR-AMES image of 500-nm PMMA at the C═O band (1728 cm⁻¹). FIG. 13b shows the IR illumination profile fitted with a 2D Gaussian function. FIG. 13c shows line profiles showing a beam FWHM of 50 μm (y-axis) and 45.7 μm (x-axis), corresponding to an elliptical illumination area with semi-major axis a=25 μm and semi-minor axis b=22.85 μm. A uniform central region with diameter D=30 μm is selected as the effective imaging area for all subsequent measurements. Scale bars: 10 μm.

FIG. 14 shows simulated temperature distribution and transient heating response in an IR-AMES system. FIG. 14a shows simulated temperature distribution and transient temperature rise of a 500-nm PMMA bead in air under a single 1-μs IR pulse. The particle reaches a peak temperature increase of ~36.7 K before cooling. FIG. 14b shows a corresponding simulation for a 50-nm PMMA bead, showing a much smaller temperature rise of ~0.41 K under the same IR pulse.

FIG. 15 shows an experimental temperature response of 500-nm PMMA particles. FIG. 15a shows a schematic of the widefield fluorescence setup used to measure temperature-dependent fluorescence of 500-nm PMMA-FITC beads in air, together with the calibration curve of normalized fluorescence intensity versus temperature change (ΔT). Fluorescence decreases linearly with temperature increase, with a slope of −0.23% per K. FIG. 15b shows a fluorescence image of 500-nm PMMA-FITC beads and the corresponding normalized fluorescence intensity modulation under IR-off and IR-on (1,728 cm⁻¹) conditions. An 8.5% fluorescence decrease corresponds to a temperature rise of ~37 K. Scale bar: 5 μm.

FIG. 16 shows AFM characterization of single IgM molecules. FIG. 16a shows AFM images of IgM deposited on silicon wafer (Si) compared with a bare Si control. The line profile (right) shows a representative IgM particle with a Gaussian-fitted full width at half maximum (ω). Scale bars: 500 nm. FIG. 16b shows an AFM image of IgM adsorbed on a gold-coated glass slide together with height profiles of individual particles. While the Gaussian-fitted ω values are similar across particles, the peak heights clearly differentiate single IgM molecules (1-1, 1-2, 1-3) from double (2-1, 2-2) and triple (3-1) IgM aggregates. Scale bar: 250 nm.

FIG. 17 shows fingerprinting of bulk IgM by IR-AMES. FIG. 17a shows an IR-AMES image of bulk IgM (100 nM) deposited on a gold-coated substrate and dried in air, shown at the amide I band (1,620-1,660 cm⁻¹). Scale bar: 1 μm. FIG. 17b shows representative spectra extracted from circled IgM aggregates in FIG. 17a. FIG. 17c shows representative average spectra for bulk IgM (n=100), which matches the FTIR spectrum of bulk dried IgM. Solid line: mean spectra, shaded region: standard-deviation.

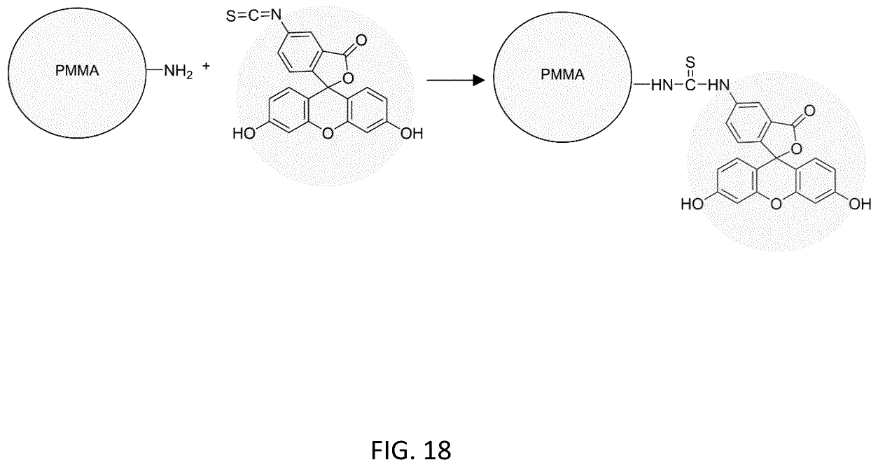

FIG. 18 shows a synthetic procedure of PMMA-FITC beads. Amine-functionalized 500-nm PMMA beads were covalently labeled with FITC via isothiocyanate group, where the fluorescein core provides temperature-sensitive green fluorescence.

FIG. 19 shows single-particle region-of-interest (ROI) selection for IR-AMES spectral analysis. Image of single IgM in air is used as the example. An integrated IR-AMES image of IgM molecules was generated by summing the hyperspectral images over the amide-I band (1,620-1,660 cm⁻¹). Individual particles were automatically detected using TrackMate in ImageJ. Circles indicate diffraction-limited ROIs (3-pixel diameter, corresponding to ~225 nm). Mean intensities within each ROI were extracted at each wavenumber to construct single-particle IR-AMES spectra. Scale bar: 1 μm.

FIG. 20 shows IR-AMES spectral processing. FIG. 20a shows raw average IR power measured at the sample plane. Sharp negative spikes in the curve arise from water vapor absorption. FIG. 20b shows an average IR power spectrum after excluding wavenumbers strongly affected by water vapor absorption, used for spectral normalization. FIG. 20c shows a raw IR-AMES spectrum extracted from a single 500-nm PMMA particle. FIG. 20d shows an IR-AMES spectrum of the same particle after spectral normalization.

What is claimed is:

1. A system for label-free, single molecule spectroscopic imaging, the system comprising:
a gold-coated substrate;
a mid-infrared (IR) optical source for generating a mid-IR beam, the mid-IR beam being directed at an oblique angle onto a portion of a sample located on the gold-coated substrate to induce a temperature change in the portion by absorption of the mid-IR beam;
a probe source for generating a probe beam, the probe beam being directed onto the gold-coated substrate under total internal reflection to generate a laterally-propagating evanescent field; and
a detector for detecting orthogonally scattered probe light from the sample.

2. The system of claim 1, further comprising a data acquisition and processing system for acquiring and processing the detected orthogonally scattered probe light from the sample to produce an IR-encoded scattering image based on differences between scattering detected during mid-IR beam excitation of the sample and scattering detected without mid-IR beam excitation of the sample.

3. The system of claim 1, wherein the gold-coated substrate is glass.

4. The system of claim 1, further comprising a barrier positioned to block reflected probe beam light.

5. The system of claim 1, wherein the mid-IR beam is directed onto the portion of the sample at a 45 degree angle of incidence.

6. The system of claim 1, wherein the mid-IR beam is pulsed.

7. The system of claim 6, wherein the mid-IR beam is pulsed in pulses of about 80 ns.

8. The system of claim 6, wherein the probe beam is a nanosecond pulsed 450-nm laser.

9. The system of claim 8, wherein the probe beam and mid-IR beam pulses are synchronized.

10. The system of claim 1, wherein the detector comprises a cmos camera.

11. A method for label-free, single molecule spectroscopic imaging, the method comprising:
generating a mid-infrared (IR) beam using a mid-IR optical source;
directing the mid-infrared (IR) beam at an oblique angle onto a portion of a sample located on a gold-coated substrate to induce a temperature change in the portion by absorption of the mid-IR beam;
generating a probe beam using a probe source;
directing the probe beam onto the gold-coated substrate under total internal reflection to generate a laterally-propagating evanescent field; and
detecting orthogonally scattered probe light from the sample using a detector.

12. The method of claim 11, further comprising acquiring and processing the detected orthogonally scattered probe light from the sample to using a data acquisition and processing system to produce an IR-encoded scattering image based on differences between scattering detected during mid-IR beam excitation of the sample and scattering detected without mid-IR beam excitation of the sample.

13. The method of claim 11, wherein the gold-coated substrate is glass.

14. The method of claim 11, further comprising block reflected probe beam light using a barrier.

15. The method of claim 11, further comprising directing the mid-IR beam onto the portion of the sample at a 45 degree angle of incidence.

16. The method of claim 11, further comprising pulsing the mid-IR beam.

17. The method of claim 16, further comprising pulsing the mid-IR beam in pulses of about 80 ns.

18. The method of claim 16, wherein the probe beam is a nanosecond pulsed 450-nm laser.

19. The method of claim 18, further comprising synchronizing the probe beam and mid-IR beam pulses.

20. The method of claim 11, wherein the detector comprises a complementary metal-oxide-semiconductor (CMOS) camera.
